(19) United States
(12) Patent Application Publication
(10) Pub. No.: US 2026/0003719 A1
(43) Pub. Date: Jan. 1, 2026

(54) ARTIFICIAL INTELLIGENCE (AI) FOR AUTOMATING DATA CENTER SERVER DIAGNOSIS AND ACTION

(71) Applicant: Rakuten Mobile, Inc., Tokyo (JP)

(72) Inventor: Yu-Chun LIN, Tokyo (JP)

(21) Appl. No.: 18/757,502

(22) Filed: Jun. 28, 2024

(51) Int. Cl. G06F 11/07; G06N 5/02

(52) U.S. Cl. CPC G06F 11/079; G06F 11/0709; G06F 11/0793; G06N 5/027

(57) ABSTRACT

A trouble ticket associated with an incident is automatically triggered. A task is initiated to collect system event logs from one or more servers based on the trouble ticket. A system document is obtained that includes an event list. The event list and the system event logs are provided to an Artificial Intelligence (AI) engine for analysis. An AI diagnosis result is generated by the AI engine. The AI diagnosis result is received from the AI engine. A remote action is executed to resolve the incident based on the AI Diagnosis Result. Action result logs are obtained in response to executing the remote action. A result document is generated that includes a result of the executing the remote action. The result document is provided to the AI engine for training a model used by the AI engine to generate the AI diagnosis result.

### FIELD

The present disclosure relates to artificial intelligence (AI) for automating data center server diagnosis and action.

### BACKGROUND

The information disclosed in this background section is only for enhancement of understanding of the general background of the disclosure and should not be taken as an acknowledgement or any form of suggestion that this information forms the prior art already known to a person skilled in the art.

Operators are interested in detecting network failures, performance degradations, and understanding any impact caused by an incident. The process of managing those faults to resolution often depends on a considerable amount of human effort, manual processes and decision-making. This makes the process prone to human error, omissions, mistakes, misunderstandings, failures to check relevant information when making decisions, and the like. Manual processes cause difficulty also for operators to act optimally in response to events causing impacts to services.

Network assurance and maintenance cost is a considerable overhead for any service provider. A service provider is interested in setting the course for the right direction through prioritization and decision-making, and monitoring performance and compliance against agreed-on directions and objectives. Operators have made significant progress on automating the process of filtering alarm and event data to identify the source of faults. For example, a service desk is a platform that is used by an operator to collect data that is used to generate a problem tickets associated with incidents that take place during installation, network service operations, and customer related issues. The service desk therefore is a tool for addressing incidents impacting telecom services that have an effect on the needs and expectations of the customers.

Problem tickets are provided to a vendor that then checks relevant information associated with the problem ticket. Problem tickets are able to include information such as, for example, a ticket identification (ID), a time associated with the problem, a physical name of the impacted hardware, a cluster type, an identification of a rack where the hardware is located, and the like. The problem ticket also includes a description of the problem associated with the problem ticket.

The operation team is able to access servers to identify activity associated with the problem ticket. The operation team is then able to invite the vendor to investigate the incident associated with the problem ticket. The vendor accesses the affected server, logs into the service, and obtains the system event log. Vendor technicians check the system event log and provide suggestions for addressing the problem associated with the ticket. Then, the operation team performs follow-up tasks based on the suggestions provided by the vendor. However, vendors and the operation teams are from different companies. The process of acquiring the vendors involvement and the time for obtaining a diagnosis of the problem consumes considerable time.

### SUMMARY

In at least embodiment, a method includes automatic triggering generation of a trouble ticket associated with an incident using a Method Of Procedure (MOP). A task is executed to collect system event logs from servers based on the automatic triggering of the generation of the trouble ticket. A system document is obtained that includes an event list. The event list along with the system event logs are provided to an Artificial Intelligence (AI) engine for analysis. In response to the event list and the system event logs, an AI diagnosis result is generated by the AI engine. The AI diagnosis result is received from the AI engine. A remote action is executed to resolve the incident based on the AI Diagnosis Result.

In at least one embodiment, a system is configured to automatically trigger generation of a trouble ticket associated with an incident using a Method Of Procedure (MOP). A task is executed to collect system event logs from servers based on the automatic triggering of the generation of the trouble ticket. A system document is obtained that includes an event list. The event list along with the system event logs are provided to an Artificial Intelligence (AI) engine for analysis. In response to the event list and the system event logs, the AI engine generates an AI diagnosis result. The AI diagnosis result is received from the AI engine. A remote action is executed to resolve the incident based on the AI Diagnosis Result.

In at least one embodiment, a non-transitory computer-readable media having computer-readable instructions stored thereon, which when executed perform operations including automatic triggering generation of a trouble ticket associated with an incident using a Method Of Procedure (MOP). A task is executed to collect system event logs from servers based on the automatic triggering of the generation of the trouble ticket. A system document is obtained that includes an event list. The event list along with the system event logs are provided to an Artificial Intelligence (AI) engine for analysis. In response to the event list and the system event logs, the AI engine generates an AI diagnosis result. The AI diagnosis result is received from the AI engine. A remote action is executed to resolve the incident based on the AI Diagnosis Result.

### BRIEF DESCRIPTION OF THE DRAWINGS

Features, aspects, and advantages of embodiments of the disclosure will be described below with reference to the accompanying drawings, in which like reference numerals denote like elements, and wherein:

FIG. 1 illustrates a mobile network according to at least one embodiment.

FIG. 2 is a block diagram of an Open Radio Access Network (O-RAN) according to at least one embodiment.

FIG. 3 illustrates a system for automating data center server diagnosis and action using Artificial Intelligence (AI) according to at least one embodiment.

FIG. 4 is a System Document according to at least one embodiment.

FIG. 5 is an Artificial Intelligence (AI) Diagnosis Response generated by the AI Engine according to at least one embodiment.

FIG. 6 is a flowchart of a method for automating data center server diagnosis and action using Artificial Intelligence (AI) according to at least one embodiment.

FIG. 7 illustrates an embodiment of a device.

### DETAILED DESCRIPTION

The following detailed description of example embodiments refers to the accompanying drawings. The present disclosure provides illustrations and descriptions, but is not intended to be exhaustive or to limit the implementations to the precise form disclosed. Modifications and variations are possible in light of the present disclosure or may be acquired from practice of the implementations. Further, one or more features or components of one embodiment may be incorporated into or combined with another embodiment (or one or more features of another embodiment). Additionally, the flowchart and description of operations provided below relate to at least one of the embodiments in the present disclosure. It should be noted that it is possible to make other embodiments that do not exactly match the flowchart and its description. It is understood that in other embodiments one or more operations may be omitted, one or more operations may be added, one or more operations may be performed simultaneously (at least in part).

It will be apparent that systems and/or methods, described herein, may be implemented in different forms of hardware, software, or a combination of hardware and software. The actual specialized control hardware or software code used to implement these systems and/or methods should not limit their implementations. Thus, the operation and behavior of the systems and/or methods are described herein without reference to specific software code. It is understood that software and hardware may be designed to implement the systems and/or methods based on the description herein.

Even though particular combinations of features are recited in the claims and/or disclosed in the specification, the particular combinations are not intended to limit the disclosure of implementations. In fact, many of these features may be combined in ways not specifically recited in the claims and/or disclosed in the specification. Even if a dependent claim directly depends on only one claim, the present disclosure may indicate that the dependent claim is dependent on other claims in the claim set.

No element, act, or instruction used herein should be construed as critical or essential unless explicitly described as such. Also, as used herein, the articles “a” and “an” (in other words, nouns not mentioned in the plural) are intended to include one or more items, and may be used interchangeably with “one or more.” Also, as used herein, the terms “has,” “have,” “having,” “include,” “including,” or the like are intended to be open-ended terms. Further, the phrase “based on” is intended to mean “based, at least in part, on” unless explicitly stated otherwise. Furthermore, expressions such as “at least one of [A] and [B],” “[A] and/or [B],” or “at least one of [A] or [B]” are to be understood as including only A, only B, or both A and B.

Further, spatially relative terms, such as “beneath,” “below,” “lower,” “above,” “upper” and the like, are used herein for ease of description to describe one element or feature's relationship to another element(s) or feature(s) as illustrated in the figures. The spatially relative terms are intended to encompass different orientations of the device in use or operation in addition to the orientation depicted in the figures. The apparatus is otherwise oriented (rotated 90 degrees or at other orientations) and the spatially relative descriptors used herein likewise are interpreted accordingly.

The foregoing disclosure provides illustration and description but is not intended to be exhaustive or to limit the implementations to the precise form disclosed. Modifications and variations are possible in light of the above disclosure or may be acquired from practice of the implementations.

In at least one embodiment, a trouble ticket associated with an incident using a Method Of Procedure (MOP) is automatically triggered. A task is initiated to collect system event logs from one or more servers based on the trouble ticket. A system document is obtained that includes an event list. The event list along with the system event logs are provided to an Artificial Intelligence (AI) Engine for analysis. In response to the event list and the system event logs, an AI diagnosis result is generated by the AI Engine. The AI diagnosis result is received from the AI Engine. A remote action is executed to resolve the incident based on the AI Diagnosis Result. Action result logs are obtained in response to executing the remote action. The action result logs and the AI diagnosis result are attached to the trouble ticket. The trouble ticket is provide to a service desk. An operation team verifies the result of the remote action based on the trouble ticket, and communicates the closing of the trouble ticket after verifying that the incident has been addressed. In response to the incident not being able to be addressed by the executing the remote action, the incident is resolved on-site by the operation team. In response to obtaining action result logs based on the executing the remote action, a result document is generated that includes a result of the executing the remote action and the result document is provided to a visualization tool. The result document is provided to the AI Engine for training a model used by the AI Engine to generate the AI diagnosis result. The AI Engine analyzes the result document and provides a summary and an updated data set used by the visualization tool.

Embodiments described herein provide method that provides one or more advantages. For example, Artificial Intelligence (AI) is used for data center server diagnosis and action simplifies the diagnosis process, produces faster results, improves diagnosis performance, reduces development and operational cost. AI automates the production diagnosis process and automatically addresses hardware issues through remote commands.

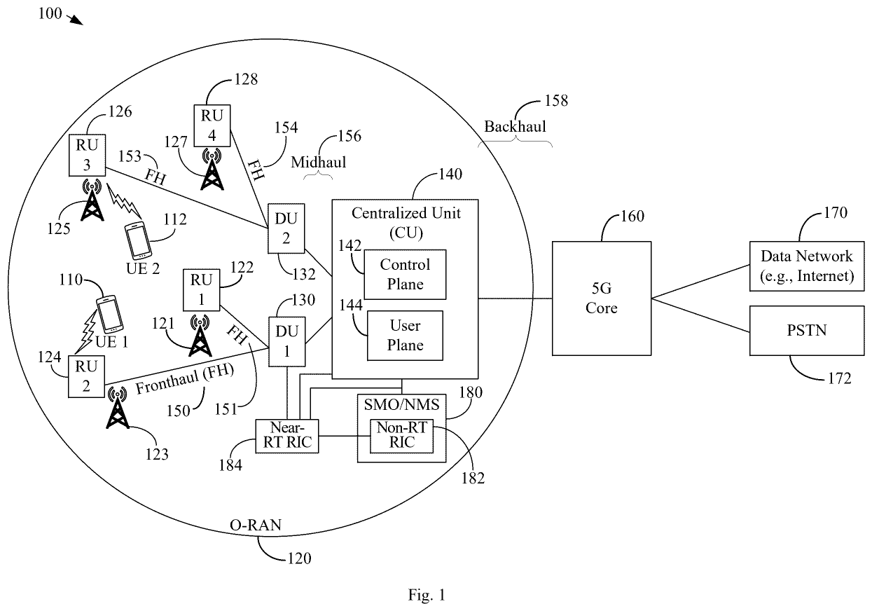

FIG. 1 illustrates a mobile network 100 according to at least one embodiment.

In FIG. 1, UE 1 (User Equipment 1) 110 and UE 2 112 access Mobile Network 100 via a Radio Access Network 120.

Radio Access Network 120 includes Radio Towers 121, 123, 125, and 127. Radio Towers 121, 123, 125, 127 are associated with RU (Radio Unit) 1 122, RU 2 124, RU 3 126, and RU 4 128, respectively.

RU 1 122, RU 2 124, RU 3 126, RU 4 128 handle the Digital Front End (DFE) and the parts of the PHY layer, as well as the digital beamforming functionality. RU 1 122 and RU 2 124 are associated with Distributed Unit (DU) 1 130, and RU 3 126 and RU 4 128 are associated with DU 2 132. DU 1 130 and DU 2 132 are responsible for real time Layer 1 and Layer 2 scheduling functions. For example, in 5G, Layer-1 is the Physical Layer, Layer-2 includes the Media Access Control (MAC), Radio link control (RLC), and Packet Data Convergence Protocol (PDCP) layers, and Layer-3 (Network Layer) is the Radio Resource Control (RRC) layer. Layer 2 is the data link or protocol layer that defines how data packets are encoded and decoded, how data is to be transferred between adjacent network nodes. Layer 3 is the network routing layer and defines how data is moves across the physical network.

DU 1 130 is coupled to the RU 1 122 and RU 2 124, and DU 2 132 is coupled to RU 3 126 and RU 4 128. DU 1 130 and DU 2 132 run the RLC, MAC, and parts of the PHY layer. DU 1 130 and DU 2 132 include a subset of the eNB/gNB functions, depending on the functional split option, and operation of DU 1 130 and DU 2 132 are controlled by Centralized Unit (CU) 140. CU 140 is responsible for non-real time, higher L2 and L3. Server and relevant software for CU 140 is able to be hosted at a site or is able to be hosted in an edge cloud (datacenter or central office) depending on transport availability and the interface for the Fronthaul connections 150, 151, 153, 154. The server and relevant software of CU 140 is also able to be co-located at DU 1 130 or DU 2 132, or is able to be hosted in a regional cloud data center.

CU 140 handles the RRC and PDCP layers. The gNB includes CU 140 and one or more DUs, e.g., DU 1 130, connected to CU 140 via Fs-C and Fs-U interfaces for a Control Plane (CP) 142 and User Plane (UP) 144, respectively. CU 140 with multiple DUs, e.g., DU 1 130, and DU 2 132, support multiple gNBs. The split architecture enables a 5G network to utilize different distribution of protocol stacks between CU 140, and DU 1 130 and DU 2 132, depending on network design and availability of the Midhaul 156. While two connections are shown between CU 140 and DU 1 130 and DU 2 132, CU 140 is able to implement additional connections to other DUs. CU 150, in 5G, is able to implement, for example, 256 endpoints or DUs. CU 140 supports the gNB functions such as transfer of user data, mobility control, RAN sharing (MORAN), positioning, session management, etc. However, one or more functions are able to be allocated to the DU. CU 140 controls the operation of DU 130 and DU 132 over the Midhaul interface 156.

Backhaul 158 connects the 4G/5G Core 160 to the CU 140. Core 160 may be, for example, up to 200 km away from the CU 140. Core 160 provides access to voice and data networks, such as Internet 170 and Public Switched Telephone Network (PSTN) 172.

RAN 120 is able to implement beamforming that allows for directional transmission or reception. 5G beamforming enables 5G connections to be more focused toward a receiving device. RAN 120 is also able to implement MIMO (Multiple Input Multiple Output), including mMIMO (massive MIMO), to provide an increases in throughput and signal-to-noise ratio (SNR). MIMO improves the radio link by using the multiple paths over which signals travel from the transmitter to the receiver. The multiple paths are de-correlated and this provides the opportunity to send multiple data streams over them.

Massive MIMO and dense small cell deployments are being implemented to improve radio resource efficiency. However, the intra-cell interference from neighboring cells presents a serious problem. According to at least one embodiment, the modeling of interference patterns in a Massive MIMO deployment is used to identify interfering beams between different sectors so that interference optimization techniques are able to be applied to address interference.

A Service Management and Orchestration (SMO)/NMS 180 oversees the orchestration aspects, and the management and automation of RAN elements. SMO 180 supports O1, AI and O2 interfaces. Non-RT RIC (non-Real-Time RAN Intelligent Controller) 182 enables non-real-time control and optimization of RAN elements and resources, AI/ML workflow including model training and updates, and policy-based guidance of applications/features in Near-RT RIC 184. Near-RT RIC 184 enables near-real-time control and optimization of O-RAN elements and resources via fine-grained data collection and actions over the E2 interface. Near-RT RIC 184 includes interpretation and enforcement of policies from Non-RT RIC 182, and supports enrichment information to optimize control function.

Near-RT RIC 184 obtains information associated with the beams that are passed to Non-RT RIC 182 and processed, for example, by an rApp at the Non-RT RIC 184, to generate an interference matrix. xApps are hosted on the Near-RT RIC 184 and are able to be used to optimize radio spectrum efficiency. rApps are specialized microservices operating on the Non-RT RIC 211. xApps and rApps provide control and management features and functionality.

While an O-RAN 120 is shown in FIG. 1, embodiments described herein are applicable to O-RANs and Virtualized RANs (vRANs). O-RAN and vRAN disaggregate RAN hardware into three modules or functions, e.g., Radio Units (RUS) 122, 124, 126, 128, Distributed Units (DUs) 130, 132, and Centralized Units (CUs) 140. The software for these functions is decoupled from the purpose-built hardware and run on standardized, common off-the-shelf (COTS) hardware. O-RAN 120 further opens the software interfaces between radios and other network elements, whereas the interfaces between components in vRAN are still primarily based on closed or proprietary interfaces. A RAN Intelligent Controller (RIC) including Non-RT RIC 182 and RT RIC 184, is also able to be integrated with Multi-Access Edge Cloud (MEC) and vRAN. Herein, Radio Nodes refers to RUs 122, 124, 126, 128, Dus 130, 132, and CUs 140. According to at least one embodiment, artificial intelligence (AI) is used for automating data center server diagnosis and action.

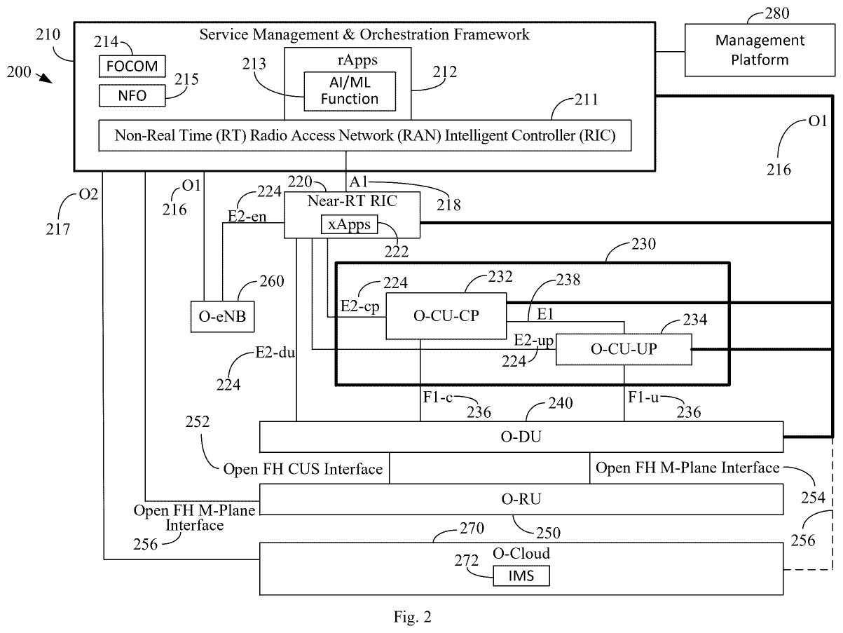

FIG. 2 is a block diagram of an Open Radio Access Network (O-RAN) 200 according to at least one embodiment.

In FIG. 2, Service Management and Orchestration (SMO) Framework 210 is an automation platform for Open RAN Radio Resources. SMO 210 oversees lifecycle management of network functions as well as O-Cloud. SMO 210 includes a Non-Real-Time (RT) Radio Access Network (RAN) Intelligent Controller (RIC) 211. SMO 210 also defines various SMO interfaces, such as the O1 216, O2 217, and A1 218 interfaces.

The AI interface 218 enables communication between the Non-RT RIC 211 and a Near-RT RIC 220 and supports policy management, data transfer, and machine learning management. The AI interface 218 is also used for policy guidance. SMO 210 provides fine-grained policy guidance such as getting User-Equipment to change frequency, and other data enrichments to RAN functions over the AI interface 218.

The O1 216 interface connects the SMO 210 to the RAN managed elements, which include the Near-RT RIC 220, O-RAN Centralized Unit (O-CU) 230, O-RAN Distributed Unit (O-DU) 240, and the Open Evolved NodeB (O-eNB) 260. The management and orchestration functions are received by the managed elements via the O1 interface 216. The SMO 210 in turn receives data from the managed elements via the O1 interface 216 for AI model training at the Non-RT RIC 211. The O1 interface 216 is further used for managing the operation and maintenance (OAM) of multi-vendor Open RAN functions including fault, configuration, accounting, performance and security management, software management, and file management capabilities.

The O2 interface 217 is used to support cloud infrastructure management and deployment operations with O-Cloud 270 infrastructure that hosts the Open RAN functions in the network. The O2 interface 217 supports orchestration of O-Cloud infrastructure resource management (e.g., inventory, monitoring, provisioning, software management and lifecycle management) and deployment of the Open RAN network functions, providing logical services for managing the lifecycle of deployments that use cloud resources.

SMO 210 provides a common data collection platform for management of RAN data as well as mediation for the O1 216, O2 217, and A1 218 interfaces. Licensing, access control and AI/ML lifecycle management are supported by the SMO 210, together with legacy north-bound interfaces. SMO 210 also supports existing Operational Support System (OSS) functions, such as service orchestration, inventory, topology and policy control.

SMO 210 also implements Federated Open Cloud Orchestration & Management (FOCOM) 214 and Network Function Orchestrator (NFO) 215. FOCOM 214 is responsible for managing the infrastructure (e.g., Clouds, Data centers, Clusters, Resources, etc.) on which the Network Slices, Services and Functions are deployed. The NFO 215 orchestrates the RAN network functions on top of them.

The Non-RT RIC 211 enables non-real-time (>1 second) control of RAN elements and their resources through cloud-native microservice-based applications, which are referred to as rApps 212. An rApp 212 is able to implement an AI/ML Function 213. Non-RT RIC 211 communicates with applications called xApps 222 running on a Near-RT RIC 211 to provide policy-based guidance for edge control of RAN elements and their resources. The Non-RT RIC 211 provides non-real-time control and optimization of RAN elements and resources, AI/ML workflow, including model training of the AI/ML Function 213, updates, and policy-based guidance of applications/features in Near-RT RIC 220.

Near-RT RIC 220 controls RAN infrastructure at the cloud edge. Near-RT RIC 220 controls RAN elements and their resources with optimization actions that typically take 10 milliseconds to one second to complete. The Near-RT RIC 220 receives policy guidance from the Non-RT RIC 211 and provides policy feedback to the Non-RT RIC 211 through the xApps 222.

The xApps 222 are used to enhance the RAN's spectrum efficiency. The Near-RT RIC 220 manages a distributed collection of “southbound” RAN functions, and also provides “northbound” interfaces for operators: the O1 216 and A1 218 interfaces to the Non-RT RIC 211 for the management and optimization of the RAN. The Near-RT RIC 220 is thus able to self-optimize across different RAN types, like macros, Massive MIMO and small cells, maximizing network resource utilization for 5G network scaling.

Within the Near-RT RIC 220, the xApps 222 communicate via defined interface channels. An internal messaging infrastructure provides the framework to handle conflict mitigation, subscription management, app lifecycle management functions, and security. Data transfers are implemented via the E2 interface.

The O-RAN is split into a Central Unit (CU) 230, a Distributed Unit (DU) 240, and a Radio Unit (RU) 250. The CU 230 is further split into two logical components, one for the Control Plane (CP) 232, and one for the User Plane (UP) 234. The logical split of the CU 230 into the CP 232 and UP 234 allows different functionalities to be deployed at different locations of the network, as well as on different hardware platforms. For example, CUs 230 and DUs 240 can be virtualized on servers at the edge, while the RUs 250 are able to be implemented on Field Programmable Gate Arrays (FPGAs) and Application-specific Integrated Circuits (ASICs) boards and deployed close to RF antennas.

The O-RAN Distributed Unit (O-DU) 240 is an edge server that includes baseband processing and radio frequency (RF) functions. The O-DU 240 hosts radio link control (RLC), MAC, and a physical layer with network function virtualization or containers. O-DU 240 supports one or more cells, and the O-DUs are able to support one or more beams to provide the operating support for O-RU 250 by CUS (Control, User, and Synchronization) planes 252, and management (M) planes 254 through front-haul interfaces.

The O-RU 250 processes radio frequencies received by the physical layer of the network. The processed radio frequencies are sent to the O-DU 240 through FrontHaul (FH) interfaces 252, 254. The O-RU 250 hosts the lower PHY Layer Baseband Processing and RF Front End (RF FE), and is designed to support multiple 3GPP split options.

An Open-Evolved Node B (O-eNB) 260 provides the hardware aspect of the O-RAN. The management and orchestration functions are received by the managed elements via the O1 interface 216. The SMO 210 in turn receives data from the managed elements via the O1 interface 216 for AI model training of AI/ML Functions 213 implemented by rApps 213 at Non-RT RIC 211. The O-eNB 260 communicates with the Near-RT RIC 220 via the E2 interface 224. E2 224 enables near-real-time loops through the streaming of telemetry from the RAN and the feedback with control from the Near-RT RIC 220. The E2 interface 224 connects the Near-RT RIC 220 with an E2 node, such as the O-CU-CP 232, O-CU-UP 234, the O-DU 240, and the O-cNB 260. An E2 node is connected to one Near-RT RIC 220, while Near-RT RIC 220 is able to be connected to multiple E2 nodes 224. The protocols over the E2 interface 224 are based on the control plane and supports services and functions of Near-RT RIC 220.

An F1 Interface 236 connects the O-CU-CP 232 and the O-CU-UP 234 to the O-DU 240. Thus, the F1 interface 236 is broken into control and user plane subtypes and exchanges data about the frequency resource sharing and other network statuses. One O-CU 230 can communicate with multiple O-DUs 240 via F1 interfaces 236.

An E1 238 interface connects the O-CU-CP 232 and the O-CU-UP 234. The E1 Interface 238 is used to transfer configuration data and capacity information between the O-CU-CP 232 and the O-CU-UP 234. The configuration data ensures the O-CU-CP 232 and the O-CU-UP 234 are able to interoperate. The capacity information is sent from the O-CU-UP 234 to the O-CU-CP 232 and includes the status of the O-CU-UP 234.

The O-DU 240 communicates with the O-RU 250 via an Open Fronthaul (FH) Control, User, and Synchronization (CUS) Plane Interface 252 and an M-Plane (Management Plane) Interface 254. As part of the CUS Plane Interface 252, the C-Plane (control plane) is a frame format that carries data in real-time control messages between the O-DU 240 and O-RU 250 for use to control user data scheduling, beamforming weight selection, numerology selection, etc. Control messages are sent separately for downlink (DL)-related commands and uplink (UL)-related commands.

The U-Plane carries the user data messages between the O-DU 240 and O-RU 250, such as the in-phase and quadrature-phase (IQ) sample sequence of the orthogonal frequency division multiplexing (OFDM) signal. The S-plane includes synchronization messages used for timing synchronization between O-DU 240 and O-RU 250. The Control and User Plane is also used to send information specifying beamforming weights from the O-DU 240 to O-RU 250. Other information includes time resource and frequency resource information.

The M-Plane 254 connects the O-RU 250 to the O-DU 240, and an optional M-Plane 256 connects the O-RU 250 to the SMO 210. The O-DU 240 uses the M-Plane 254 to manage the O-RU 250, while the SMO 210 is able to provide FCAPS (Fault, Configuration, Accounting, Performance, Security) services to the O-RU 250. The M-plane 254 supports the management features including startup installation, software management, configuration management, performance management, fault management and file management.

The M-Plane 254 is used by the O-DU 240 to retrieve the capabilities of the O-RU 250 and to send relevant configuration related to the C-Plane and U-Plane (data plane) to the O-RU 250. Together the O1 216 and Open-Fronthaul M-plane 254 interfaces provide a FCAPS interface with configuration, reconfiguration, registration, security, performance, monitoring aspects exchange with individual nodes, such as O-CU-CP 232, O-CU-UP 234, O-DU 240, and O-RU 250, as well as Non-RT RIC 220. O-Cloud 270 connects to Infrastructure Management Framework 280 via O2 Interface 217.

The O-Cloud 270 provides physical or logical infrastructure resources and performs workload management for O-RAN network functions. The O-Cloud 270 includes resource discovery and administration, network function provisioning, network function Fault, Configuration, Accounting, Performance, and Security (FCAPS), and software life cycle management. The O-Cloud 270 provides Infrastructure Management Services (IMS) 272 that communicates with the SMO 210.

The IMS 272 is responsible for physical resource allocation based on the request from the SMO 210 and resource tracking and management. The IMS 272 builds physical and logical inventories and shares them with the SMO 210 through the O2-M interface 217. The SMO 210 receives the inventory information from the IMS 272, updates its inventory accordingly, and makes a request to allocate a resource based on the inventory updates. The IMS 272 also provisions infrastructure resources and flexibly matches the resource demands of the O-RAN network functions.

Non-RT RIC 211 collects from the O-Cloud 270 Fault, Configuration, Accounting, Performance, Security (FCAPS) data over the O2 interfaces, and collects data from E2 node over the O1 interface. A Management Platform 280 is used to provide automated data center for automating server diagnosis and action using artificial intelligence.

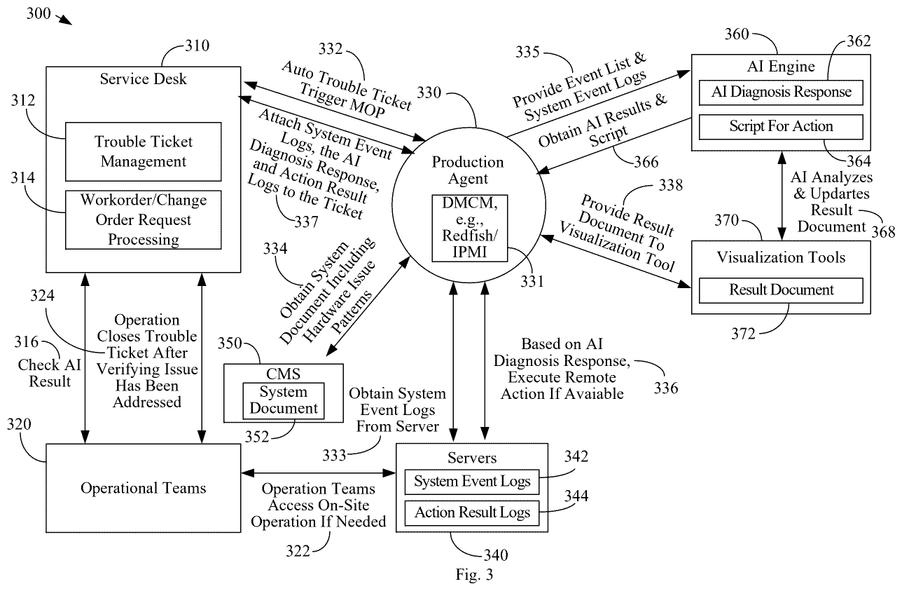

FIG. 3 illustrates a system 300 for automating data center server diagnosis and action using Artificial Intelligence (AI) according to at least one embodiment.

In FIG. 3, a Service Desk 310 provides end-to-end Trouble Tickets Management 312 for incidents that take place during installation, and network service operations, as well as incidents related to customer related issues. The Service Desk 310 also handles the assignment, routing, prioritization, and escalation of trouble tickets. The Service Desk 310 handles Workorder And Change Order Processing 314. The Service Desk 310 is able to provide network visibility, planning, orchestration, and operation of a complete network over a cloud network. The Service Desk 310 is able to use applications that operate over the cloud to offer planning and maintenance of the life cycle of a network. The Service Desk 310 is also able to communicate with Operation Teams 320 in response to a trouble ticket.

A Production Agent 330 collects data from one or more Servers 340 in the network. For example, the Production Agent 300 is able to provide Data Management, Collecting, And Monitoring (DMCM) 331, such as provided by Distributed Management Task Force (DMTF) Redfish and the Intelligent Platform Management Interface (IPMI). Redfish and IPMI are able to fetch server information for diagnosis and place actions with Method of Procedures (MOPs). The Production Agent 330 interfaces with Content Management Systems (CMS) 350, one or more Servers 340, an Artificial Intelligence (AI) Engine 360, and Visualization Tools 370. For example, Box is an example of a Content Management System (CMS) 350. Box is a cloud-based content management system that provide collaboration, security, analytics, and other features related to files and information. Box stores files in an online folder system that can be accessed from any device with an internet connection. Domo is an example of Visualization Tools 370 that is able to collect, store, prepare, organize and visualize data. However, those skilled in the art understand that embodiments described herein are not meant to be limited to the examples described here. Other Data Management, Collecting, And Monitoring (DMCM) 332, Content Management Systems (CMS) 350, and Visualization Tools 370 are able to be used without departing from embodiments described herein.

The System 300 initiates automated data center server diagnosis and action using Artificial Intelligence (AI). A hardware Method of Procedure (MOP) is used to trigger the automatic generation of the Trouble Ticket 332 by the Production Agent 330.

System Event Logs 342 are obtained 333 by the Production Agent 330 from one or more Servers 340. The System Event Logs 342 are obtained from one or more Servers 340 based on the automatic generation of the Trouble Ticket 332. A task is triggered to collect the System Event Logs 342 from one or more Servers 340. Thus, the Operation Team 320 is able to obtain the System Event Logs 342 from the one or more Servers 340 without logging into one or more Servers 340 because the System Event Logs are obtained 333 from the one or more Servers 340 automatically by Production Agent 330. The Production Agent 330 collects the System Event Logs 342 from one or more Servers 340 using, for example, DMCM 332 such as one or more of IPMI, Redfish, and the like. For example, the Production Agent 330 is able to run a script for automatically obtaining the System Event Logs 333 from the one or more Servers 340. The Production Agent 330 is thus able to retrieve service information, modify a configuration, perform a firmware upgrade, and the like.

A System Document 352 is obtained 334 by the Production Agent 330. A System Document 352 includes an Event List and Hardware Event Patterns. The System Document 352 is stored in a Content Management System (CMS) 350. The System Document 352 is provided by a vendor and maintained by Content Management System (CMS) 350. An Event List in System Document 352 includes a Description of Events, associated Recommended Actions, and Patterns. The System Document 352 is fetched automatically and thus is not selected manually.

The System Document 352 along with the System Event Logs 342 are provided 335 to the AI Engine 360 for analysis and for generating an AI Diagnosis Response 362 based on the System Event Logs 342 and the Event List of the System Document 352. The AI 360 is able to perform a task for addressing the incident associated with the trouble ticket. Otherwise, a vendor is consulted for a hardware problem or develops code for recognizing hardware issues and generating follow up action. For example, a specific event is associated with different actions. A pattern is associated with an event and code is developed for an action because the location of the hardware problem is able to be different even in response to the property associated with the event being the same. For a location, the pattern is used to fetch the error for automatic diagnosis. In addition, the vendor has to go event-by-event, which is time consuming. According to at least one embodiment, the System Event Log 352 and System Document 252 are used by the AI 360 to generate AI Diagnosis Response 362 and a corresponding Script 364 for addressing the incident associated with the trouble ticket. The AI Engine 360 provides 366 the AI Diagnosis Response 362 and Script 364 to the Production Agent 330.

Based on the AI Diagnosis Response 362, the Script For Action 364 is able to be implemented remotely to resolve the issue without physically going on site to replace hardware. For example, DMCM 331, such as IPMI and/or Redfish, are able to be used by the Production Agent 330 to execute Remote Action 336 to one or more remote Server 340, such as rebooting the one or more Servers 340, upgrading firmware of the one or more Servers 340, and the like.

The Production Agent 330 obtains Action Result Logs 344 from the one or more Servers 340 in response to executing the Remote Action 336. Action Result Logs 344 regarding the execution of the Remote Action 336, and the AI Diagnosis Result 362 are attached to the trouble ticket 337 by the Production Agent 330 that is provided to the Service Desk 310. Based on the trouble ticket, Operation Team 320 checks 316 the Action Result Logs 344. The Operations Team 320 is able to proceed to the site 322 to perform on-site work on the one or more Servers 340 in response to the incident not being able to be addressed remotely. The Operation Team 320 communicates the closing of the ticket 324 after verifying that the incident has been addressed.

The Action Result is included in a Result Document 372. The Production Agent 330 provides 338 the Result Document 372 to a Visualization Tool 370. The Visualization Tool 372 generates data visualizations for the retrieved data. AI Engine 360 is able to analyze and update the data set 368 used by the Visualization Tool 370. The AI Engine 360 is also able to uses the Result Document 372 for training the model used by the AI Engine 360. Thus, the AI Engine 360 is able to improve the automatic response to incidents based on the results.

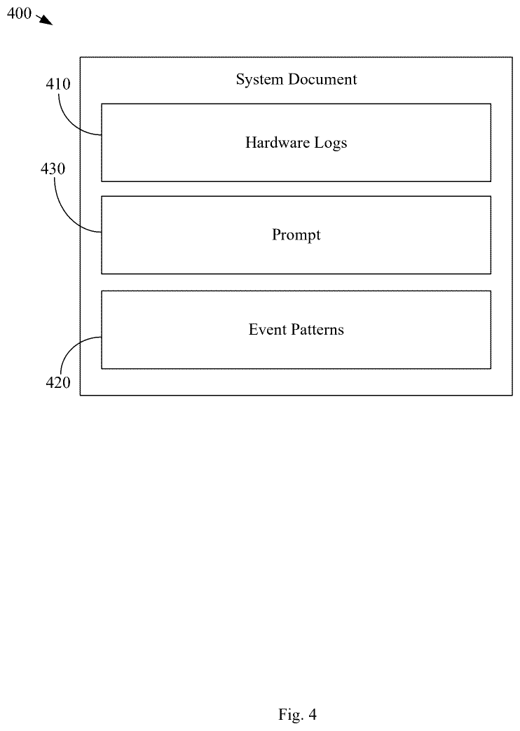

FIG. 4 is a System Document 400 according to at least one embodiment.

In FIG. 4, the System Document 400 includes Hardware Logs 410 and Event Patterns 420. The Hardware Logs 410 identify activities and incidents associated with a server. Event patterns 420 include information for identifying incidents and actions. The System Document 400 also includes a Prompt 430 that is used to request a solution, such as identifying a problem and actions, and removing asserted and de-asserted events. Those skilled in the art understand that the System Document 400 described herein is meant as an example and the System Document 400 is able to include more information, less information, or different information.

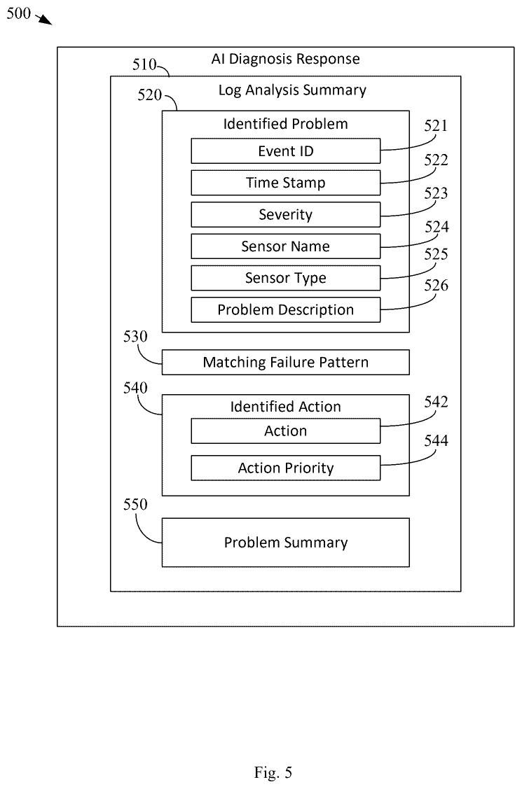

FIG. 5 is an Artificial Intelligence (AI) Diagnosis Response 500 generated by the AI Engine according to at least one embodiment.

As shown in FIG. 5, the AI Diagnosis Response 500 includes a Log Analysis Summary 510 that is based on the System Event Log, the Failure Pattern, and an Action Table. The Log Analysis Summary 510 includes an Identified Problem 520. The Identified Problem 520 includes, for example, an Event ID 521, a Time Stamp 522, a Severity 523 associated with an incident, a Sensor Name 524, a Sensor Type 525, and a Problem Description 526. A Matching Failure Pattern 530 provides a description of the failure pattern that matches the related information. An Identified Action 540 involves an Action 542 to be performed to address the problem, and an Action Priority 544. A Problem Summary 550 provides a general description for the problem and action along with preventive measures. However, those skilled in the art understand that the AI Diagnosis Response 500 described herein is meant as an example and the AI Diagnosis Response 500 is able to include more information, less information, or different information.

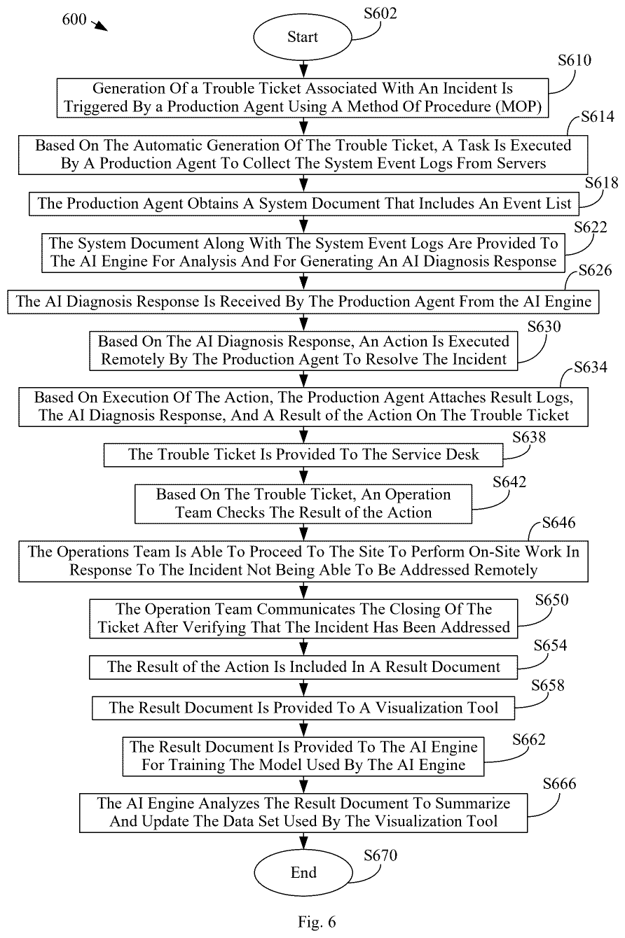

FIG. 6 is a flowchart 600 of a method for automating data center server diagnosis and action using Artificial Intelligence (AI) according to at least one embodiment.

In FIG. 6, the process starts S602 and generation of a trouble ticket associated with an incident is triggered by a production agent using a Method Of Procedure (MOP) S610. Referring to FIG. 3, the System 300 initiates automated data center server diagnosis and action using Artificial Intelligence (AI). A hardware Method of Procedure (MOP) is used to trigger the automatic generation of the Trouble Ticket 332 by the Production Agent 330.

Based on the automatic generation of the trouble ticket, a task is executed by a production agent to collect the system event logs from servers S614. Referring to FIG. 3, System Event Logs 342 are obtained 333 by the Production Agent 330 from Servers 340. The System Event Logs 342 are obtained from Servers 340 based on the automatic generation of the Trouble Ticket 332. A task is executed to collect the System Event Logs 342 from Servers 340. Thus, the Operation Team 320 is able to obtain the System Event Logs 342 from the Servers 340 without logging into the Servers 340 because the System Event Logs are obtained 333 from the Servers 340 automatically by Production Agent 330. The Production Agent 330 collects the System Event Logs 342 from Servers 340 using, for example, DMCM 332 such as one or more of IPMI, Redfish, and the like. For example, the Production Agent 330 is able to run a script for automatically obtaining the System Event Logs 333 from the Servers 340. The Production Agent 330 is thus able to retrieve service information, modify a configuration, perform a firmware upgrade, and the like.

The production agent obtains a system document that includes an event list S618. Referring to FIG. 3, a System Document 352 is obtained 334 by the Production Agent 330. A System Document 352 includes an Event List and Hardware Event Patterns. The System Document 352 is stored in a Content Management System (CMS) 350. The System Document 352 is provided by a vendor and maintained by Content Management System (CMS) 350. An Event List in System Document 352 includes a Description of Events, associated Recommended Actions, and Patterns. The System Document 352 is fetched automatically and thus is not selected manually.

The system document along with the system event logs are provided to the AI Engine for analysis and for generating an AI diagnosis response S622. Referring to FIG. 3, the System Document 352 along with the System Event Logs 342 are provided 335 to the AI Engine 360 for analysis and for generating an AI Diagnosis Response 362 based on the System Event Logs 343 and the Event List of the System Document 352. The AI 360 is able to perform a task for addressing the incident associated with the trouble ticket. Otherwise, a vendor is consulted for a hardware problem or develops code for recognizing hardware issues and generating follow up action. For example, a specific event is associated with different actions. A pattern is associated with an event and code is developed for an action because the location of the hardware problem is able to be different even in response to the property associated with the event being the same. For a location, the pattern is used to fetch the error for automatic diagnosis. In addition, the vendor has to go event-by-event, which is time consuming. According to at least one embodiment, the System Event Log 352 and System Document 252 are used by the AI 360 to generate AI Diagnosis Response 362 and a corresponding Script 364 for addressing the incident associated with the trouble ticket.

The AI diagnosis response is received by the production agent from the AI Engine S626. Referring to FIG. 3, the AI Engine 360 provides 366 the AI Diagnosis Response 362 and Script 364 to the Production Agent 330.

Based on the AI diagnosis response, an action is executed remotely by the production agent to resolve the incident S630. Referring to FIG. 3, based on the AI Diagnosis Response 362, the Script For Action 364 is able to be implemented remotely to resolve the issue without physically going on site to replace hardware. For example, DMCM 331, such as IPMI and/or Redfish, are able to be used by the Production Agent 330 to execute Remote Action 336 to one or more remote Server 340, such as rebooting the one or more Servers 340, upgrading firmware of the one or more Servers 340, and the like.

Based on execution of the action, the production agent attaches system result logs, the AI diagnosis response, and a result of the action on the trouble ticket S634. Referring to FIG. 3, the Production Agent 330 obtains Action Result Logs 344 from the one or more Servers 340 in response to executing the Remote Action 336. Action Result Logs 344 regarding the execution of the Remote Action 336, and the AI Diagnosis Result 362 are attached to the trouble ticket 337 by the Production Agent 330 that is provided to the Service Desk 310.

Based on the trouble ticket, an operation team checks the result of the action S642. Referring to FIG. 3, based on the trouble ticket, the Operation Team 320 checks the Action Result 316.

The operations team is able to proceed to the site to perform on-site work in response to the incident not being able to be addressed remotely S646. Referring to FIG. 3, the Operations Team 320 is able to proceed to the site 322 to perform on-site work on the Servers 340 in response to the incident not being able to be addressed remotely.

The operation team communicates the closing of the ticket after verifying that the incident has been addressed S650. Referring to FIG. 3, the Operation Team 320 communicates the closing of the ticket 324 after verifying that the incident has been addressed.

The result of the action is included in a result document S654. Referring to FIG. 3, the Action Result is included in a Result Document 372.

The result document is provided to a visualization tool S658. Referring to FIG. 3, the Production Agent 330 provides 338 the Result Document 372 to a Visualization Tool 370. The Visualization Tool 372 generates data visualizations for the retrieved data.

The result document is provided to the AI Engine for training the model used by the AI Engine S662. Referring to FIG. 3, the AI Engine 360 is also able to uses the Result Document 372 for training the model used by the AI Engine 360. Thus, the AI Engine 360 is able to improve a response to an incident based on the results.

The AI Engine analyzes the result document to summarize and update the data set used by the visualization tool S666. Referring to FIG. 3, AI 360 is able to analyze and update the data set 368 used by the Visualization Tool 370.

The process then terminates S670.

At least one embodiment of the method includes automatic generating a trouble ticket associated with an incident using a Method Of Procedure (MOP). A task is executed to collect system event logs from servers based on the automatic triggering of the generation of the trouble ticket. A system document is obtained that includes an event list. The event list along with the system event logs are provided to an Artificial Intelligence (AI) engine for analysis. In response to the event list and the system event logs, an AI diagnosis result is generated by the AI engine. The AI diagnosis result is received from the AI engine. A remote action is executed to resolve the incident based on the AI Diagnosis Result. Action result logs are obtained in response to executing the remote action. The action result logs and the AI diagnosis result are attached to the trouble ticket. The trouble ticket is provide to a service desk. An operation team verifies the result of the remote action based on the trouble ticket, and communicates the closing of the trouble ticket after verifying that the incident has been addressed. In response to the incident not being able to be addressed by the executing the remote action, the incident is resolved on-site by the operation team. In response to obtaining action result logs based on the executing the remote action, a result document is generated that includes a result of the executing the remote action and the result document is provided to a visualization tool. From the visualization tool, the result document is provided to the AI engine for training a model used by the AI engine to generate the AI diagnosis result. The AI engine analyzes the result document and provide a summary and an updated data set to the visualization tool.

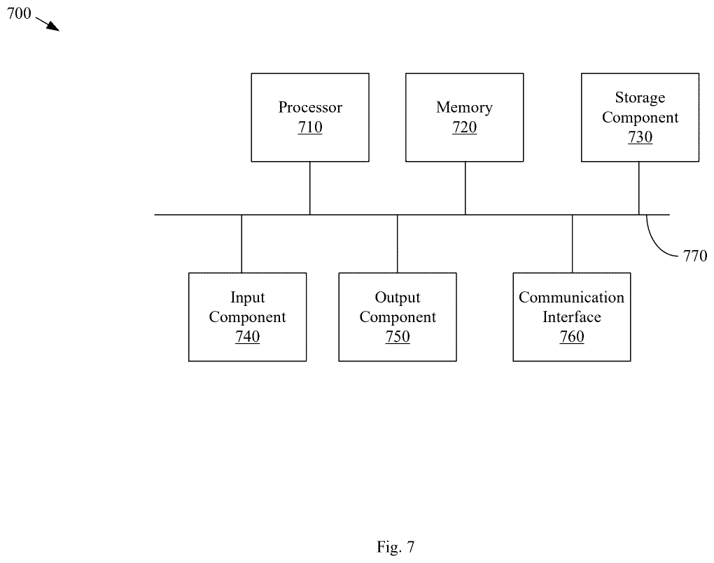

FIG. 7 illustrates an embodiment of a device 700. As shown in FIG. 7, the device 700 includes processor 710, a memory 720, a storage component 730, an input component 740, an output component 750, a communication interface 760, and a bus 770.

The processor 710, as used herein, means any type of computational circuit that may comprise hardware elements and software elements. The processor 710 may be embodied as a multi-core processor, a single core processor, or a combination of one or more multi-core processors and/or one or more single core processors, a distributed processing system, or the like. The processor 710 may be a Central Processing Unit (CPU), a graphics processing unit (GPU), an accelerated processing unit (APU), an application-specific integrated circuit (ASIC), or another type of processing component.

Memory 720 includes a non-transitory computer readable medium. Memory 720 includes a random-access memory (RAM), a read only memory (ROM), and/or another type of dynamic or static storage device (e.g., a flash memory, a magnetic memory, and/or an optical memory) that stores information and/or instructions for use by processor 710. The memory 720 comprises machine-readable instructions which are executable by the processor 710. These machine-readable instructions when executed by the processor 710 cause the processor 710 to perform one or more method steps of an embodiment described above.

Storage component 730 stores information and/or software related to the operation and use of the device 700. For example, storage component 730 may include a hard disk (e.g., a magnetic disk, an optical disk, a magneto-optic disk, and/or a solid-state disk), a compact disc (CD), a digital versatile disc (DVD), a floppy disk, a cartridge, a magnetic tape, and/or another type of non-transitory computer-readable medium, along with a corresponding drive.

Input component 740 is configured to receive information, such as user input. For example, the input component 740 may include, but not be limited to, a touch screen display, a keyboard, a keypad, a mouse, a button, a switch, and/or a microphone. Additionally, or alternatively, the input component 740 may include a sensor for sensing information (e.g., a global positioning system (GPS), an accelerometer, a gyroscope, and/or an actuator).

Output component 750 is configured to provide output information from the device 700. For example, the output component 750 may be, but not limited to, a display, a speaker, an instruction device to an external device, and/or one or more light-emitting diodes (LEDs).

Communication interface 760 is an interface that provides a communication connection to other devices, such as external devices and internal devices. The connection by the communication interface 760 can be a wired connection, a wireless connection, or a combination of wired and wireless connections, and can be a direct connection or an indirect connection via a communication network that exists between the device 700 and other devices. In other words, the standard of the communication interface 760 is not limited.

The bus 770 acts as an interconnect between the processor 710, the memory 720, the storage component 730, the input component 740, the output component 750, and the communication interface 760 of the device 700. The bus 770 may include a wired interconnection or a wireless interconnection.

The number and arrangement of components shown in FIG. 7 are provided as an example. In practice, device 700 may include additional components, fewer components, different components, or differently arranged components than those shown in FIG. 7. Additionally, or alternatively, a set of components (e.g., one or more components) of device 700 may perform one or more functions described as being performed by another set of components of device 700. Further, one or more method steps described in any of the embodiments may be performed utilizing a plurality of devices 700 in communication with one another.

Embodiments described herein provide method that provides one or more advantages. For example, Artificial Intelligence (AI) is used for data center server diagnosis and action simplifies the diagnosis process, produces faster results, improves diagnosis performance, reduces development and operational cost. AI automates the production diagnosis process and automatically addresses hardware issues through remote commands.
[1] An aspect of this description is directed to a method that includes automatic triggering generation of a trouble ticket associated with an incident using a Method Of Procedure (MOP), executing a task to collect system event logs from servers based on the automatic triggering of the generation of the trouble ticket, obtaining a system document that includes an event list, providing the event list along with the system event logs to an Artificial Intelligence (AI) engine for analysis, in response to the event list and the system event logs, generating, by the AI engine, an AI diagnosis result, receiving the AI diagnosis result from the AI engine, and executing a remote action to resolve the incident based on the AI Diagnosis Result.
[2] The method described in [1], further including obtaining action result logs in response to executing the remote action, attaching, to the trouble ticket, the action result logs and the AI diagnosis result, and providing the trouble ticket to a service desk.
[3] The method described in [2], further including verifying, by an operation team, the result of the remote action based on the trouble ticket, and communicating, by the operation team the closing of the trouble ticket after verifying that the incident has been addressed.
[4] The method described in [3], further including resolving the incident on-site by the operation team in response to the incident not being able to be addressed by the executing the remote action.
[5] The method described in [2], further including, in response to the obtaining the action result logs based on the executing the remote action, generating a result document that includes a result of the executing the remote action, and providing the result document to a visualization tool.
[6] The method described in [5], further including providing the result document to the AI engine for training a model used by the AI engine to generate the AI diagnosis result.
[7] The method described in [6], further including analyzing the result document by the AI engine to summarize and update a data set used by the visualization tool.
[8] An aspect of this description is directed to a system configured to automatically trigger generation of a trouble ticket associated with an incident using a Method Of Procedure (MOP), execute a task to collect system event logs from servers based on the automatic triggering of the generation of the trouble ticket, obtain a system document that includes an event list, provide the event list along with the system event logs to an Artificial Intelligence (AI) engine for analysis, in response to the event list and the system event logs, generate, by the AI engine, an AI diagnosis result, receive the AI diagnosis result from the AI engine, and execute a remote action to resolve the incident based on the AI Diagnosis Result.
[9] The apparatus described in [8], further configured to obtain action result logs in response to executing the remote action, attach, to the trouble ticket, the action result logs and the AI diagnosis result, and provide the trouble ticket to a service desk.
[10] The apparatus described in [9], further configured to provide the trouble ticket to an operation team for verifying the result of the executing the remote action, and receiving, from the operation team the closing of the trouble ticket after verification that the incident has been addressed.
[11] The apparatus described in [9], further configured to provide the trouble ticket to an operation team for resolving the incident on-site in response to the incident not being able to be addressed by the executing the remote action.
[12] The apparatus described in [9], further configured to, in response to the obtaining the action result logs based on the executing the remote action, generate a result document that includes a result of the executing the remote action, and to provide the result document to a visualization tool.
[13] The apparatus described in [12], further configured to provide the result document to the AI engine for training a model used by the AI engine to generate the AI diagnosis result.
[14] The apparatus described in [13], further configured to receive, from the AI engine in response to analysis of the result document by the AI engine, a summary and update of a data set used by the visualization tool.
[15] An aspect of this description is directed to a non-transitory computer-readable media having computer-readable instructions stored thereon, which when executed perform operations including automatic triggering generation of a trouble ticket associated with an incident using a Method Of Procedure (MOP), executing a task to collect system event logs from servers based on the automatic triggering of the generation of the trouble ticket, obtaining a system document that includes an event list, providing the event list along with the system event logs to an Artificial Intelligence (AI) engine for analysis, in response to the event list and the system event logs, generating, by the AI engine, an AI diagnosis result, receiving the AI diagnosis result from the AI engine, and executing a remote action to resolve the incident based on the AI Diagnosis Result.
[16] The non-transitory computer-readable media described in [15] further including obtaining action result logs in response to executing the remote action, attaching, to the trouble ticket, the action result logs and the AI diagnosis result, and providing the trouble ticket to a service desk.
[17] The non-transitory computer-readable media described in [16] further including verifying, by an operation team, the result of the remote action based on the trouble ticket, and communicating, by the operation team the closing of the trouble ticket after verifying that the incident has been addressed.
[18] The non-transitory computer-readable media described in [17] further including resolving the incident on-site by the operation team in response to the incident not being able to be addressed by the executing the remote action.
[19] The non-transitory computer-readable media described in [16] further including, in response to the obtaining the action result logs based on the executing the remote action, generating a result document that includes a result of the executing the remote action, and providing the result document to a visualization tool.
[20] The non-transitory computer-readable media described in [19] further including providing the result document to the AI engine for training a model used by the AI engine to generate the AI diagnosis result, and analyzing the result document by the AI engine to summarize and update a data set used by the visualization tool.

Separate instances of these programs can be executed on or distributed across any number of separate computer systems. Thus, although certain steps have been described as being performed by certain devices, software programs, processes, or entities, this need not be the case. A variety of alternative implementations will be understood by those having ordinary skill in the art.

Additionally, those having ordinary skill in the art readily recognize that the techniques described above can be utilized in a variety of devices, environments, and situations. Although the embodiments have been described in language specific to structural features or methodological acts, the subject matter defined in the appended claims is not necessarily limited to the specific features or acts described. Rather, the specific features and acts are disclosed as exemplary forms of implementing the claims.

What is claimed is:

1. A method, comprising:
automatic triggering generation of a trouble ticket associated with an incident using a Method Of Procedure (MOP);
executing a task to collect system event logs from servers based on the automatic triggering of the generation of the trouble ticket;
obtaining a system document that includes an event list;
providing the event list along with the system event logs to an Artificial Intelligence (AI) engine for analysis;
in response to the event list and the system event logs, generating, by the AI engine, an AI diagnosis result;
receiving the AI diagnosis result from the AI engine; and
executing a remote action to resolve the incident based on the AI Diagnosis Result.

2. The method of claim 1 further comprising obtaining action result logs in response to executing the remote action, attaching, to the trouble ticket, the action result logs and the AI diagnosis result, and providing the trouble ticket to a service desk.

3. The method of claim 2 further comprising verifying, by an operation team, the result of the remote action based on the trouble ticket, and communicating, by the operation team closing of the trouble ticket after verifying that the incident has been addressed.

4. The method of claim 3 further comprising resolving the incident on-site by the operation team in response to the incident not being able to be addressed by the executing the remote action.

5. The method of claim 2 further comprising, in response to the obtaining the action result logs based on the executing the remote action, generating a result document that includes a result of the executing the remote action, and providing the result document to a visualization tool.

6. The method of claim 5 further comprising providing the result document to the AI engine for training a model used by the AI engine to generate the AI diagnosis result.

7. The method of claim 6 further comprising analyzing the result document by the AI engine to summarize and update a data set used by the visualization tool.

8. A system for automating data center server diagnosis and action, wherein the system is configured to:
automatically trigger generation of a trouble ticket associated with an incident using a Method Of Procedure (MOP);
execute a task to collect system event logs from servers based on the automatic triggering of the generation of the trouble ticket;
obtain a system document that includes an event list;
provide the event list along with the system event logs to an Artificial Intelligence (AI) engine for analysis;
in response to the event list and the system event logs, generate, by the AI engine, an AI diagnosis result;
receive the AI diagnosis result from the AI engine; and
execute a remote action to resolve the incident based on the AI Diagnosis Result.

9. The system of claim 8 further configured to obtain action result logs in response to executing the remote action, attach, to the trouble ticket, the action result logs and the AI diagnosis result, and provide the trouble ticket to a service desk.

10. The system of claim 9 further configured to provide the trouble ticket to an operation team for verifying the result of the executing the remote action; and receiving, from the operation team closing of the trouble ticket after verification that the incident has been addressed.

11. The system of claim 9 further configured to provide the trouble ticket to an operation team for resolving the incident on-site in response to the incident not being able to be addressed by the executing the remote action.

12. The system of claim 9 further configured to, in response to the obtaining the action result logs based on the executing the remote action, generate a result document that includes a result of the executing the remote action, and to provide the result document to a visualization tool.

13. The system of claim 12 further configured to provide the result document to the AI engine for training a model used by the AI engine to generate the AI diagnosis result.

14. The system of claim 13 further configured to receive, from the AI engine in response to analysis of the result document by the AI engine, a summary and update of a data set used by the visualization tool.

15. A non-transitory computer-readable media having computer-readable instructions stored thereon, which when executed perform operations comprising:
automatic triggering generation of a trouble ticket associated with an incident using a Method Of Procedure (MOP);
executing a task to collect system event logs from servers based on the automatic triggering of the generation of the trouble ticket;
obtaining a system document that includes an event list;
providing the event list along with the system event logs to an Artificial Intelligence (AI) engine for analysis;
in response to the event list and the system event logs, generating, by the AI engine, an AI diagnosis result;
receiving the AI diagnosis result from the AI engine; and
executing a remote action to resolve the incident based on the AI Diagnosis Result.

16. The non-transitory computer-readable media of claim 15 further comprising obtaining action result logs in response to executing the remote action, attaching, to the trouble ticket, the action result logs and the AI diagnosis result, and providing the trouble ticket to a service desk.

17. The non-transitory computer-readable media of claim 16 further comprising verifying, by an operation team, the result of the remote action based on the trouble ticket; and communicating, by the operation team closing of the trouble ticket after verifying that the incident has been addressed.

18. The non-transitory computer-readable media of claim 17 further comprising resolving the incident on-site by the operation team in response to the incident not being able to be addressed by the executing the remote action.

19. The non-transitory computer-readable media of claim 16 further comprising, in response to the obtaining the action result logs based on the executing the remote action, generating a result document that includes a result of the executing the remote action, and providing the result document to a visualization tool.

20. The non-transitory computer-readable media of claim 19 further comprising:
providing the result document to the AI engine for training a model used by the AI engine to generate the AI diagnosis result; and
analyzing the result document by the AI engine to summarize and update a data set used by the visualization tool.
